(19) United States
(12) Patent Application Publication
(10) Pub. No.: US 2025/0224854 A1
(43) Pub. Date: Jul. 10, 2025

(54) PAGE DISPLAY METHOD, DISPLAY SYSTEM, AND DISPLAY INTERFACE

(71) Applicant: Wuhan United Imaging MetaHealthcare Co., Ltd., Wuhan (CN)

(72) Inventor: Hongzhi Liu, Wuhan (CN)

(21) Appl. No.: 19/012,981

(22) Filed: Jan. 8, 2025

(30) Foreign Application Priority Data
Jan. 8, 2024 (CN) 202410026307.2

(51) Int. Cl. G06F 3/0483; G06F 40/14

(52) U.S. Cl. CPC G06F 3/0483; G06F 40/14

(57) ABSTRACT

The present disclosure relates to a page display method, device, system, display interface and storage medium. The page display method includes: obtaining target information from an external storage device, and obtaining a target page element corresponding to the target information from an information management library storing a page element group, the page element group including hierarchical page elements, and constructing and displaying a target page corresponding to the target information based on the target page element.

### CROSS-REFERENCE TO RELATED APPLICATIONS

The present application claims priority to Chinese patent application No. 2024100263072, filed on Jan. 8, 2024, and entitled “PAGE DISPLAY METHOD, DEVICE, SYSTEM, DISPLAY INTERFACE AND STORAGE MEDIUM”, the entire content of which is incorporated herein by reference.

### TECHNICAL FIELD

The present disclosure relates to the field of computer devices, and in particular, to a page display method, a display system, and a display interface.

### BACKGROUND

In hospitals, when the number of patients increases and each patient's consultation time becomes longer, recording patient information and medical data becomes a tedious and heavy task for medical staff.

In conventional technologies, most hospitals employ informatization systems, and medical staff can input information through web pages on terminals and synchronize the input information to the hospital's system. However, entering the page where information needs to be input is complicated and inefficient.

### SUMMARY

A page display method, a display system, and a display interface are provided.

In a first aspect, a page display method is provided in the present disclosure, which includes obtaining target information from an external storage device, and obtaining a target page element corresponding to the target information from an information management library storing a page element group, the page element group including hierarchical page elements, and constructing and displaying a target page corresponding to the target information based on the target page element.

In some embodiments, obtaining the target information from the external storage device, and obtaining the target page element corresponding to the target information from the information management library storing the page element group includes: performing a read operation on the external storage device to obtain address information of the target page in the external storage device, and obtaining the target page element from the information management library according to the address information.

In some embodiments, obtaining the target page element from the information management library according to the address information includes: determining the page element corresponding to reference address information in the information management library whose similarity with obtained address information is greater than or equal to a preset threshold as the target page element.

In some embodiments, the target page element includes display parameters and first default values of the display parameters. Constructing and displaying the target page corresponding to the target information based on the target page element includes: constructing and displaying the target page corresponding to the target information based on the display parameters and the first default values.

In some embodiments, the method further includes performing a read operation on the external storage device to obtain second default values. Constructing and displaying the target page corresponding to the target information based on the target page element includes constructing and displaying the target page corresponding to the target information based on the target page element and the second default values.

In some embodiments, constructing and displaying the target page corresponding to the target information based on the target page element and the second default values includes: obtaining a regular expression corresponding to the target page element, verifying the second default values according to the regular expression, and if the verification is passed, constructing and displaying the target page corresponding to the target information based on the target page element and the second default values.

In some embodiments, obtaining the target information from the external storage device includes: performing a first read operation on the external storage device to obtain a key of the external storage device, and verifying the key, and if the verification is passed, performing a second read operation on the external storage device to obtain the target information.

In a second aspect, a page display system is provided in an embodiment of the present disclosure. The page display system includes a terminal and an external storage device. The external storage device is configured to store target information. The terminal is configured to perform a page display method according to any one of the embodiments described above.

In a third aspect, a display interface is provided in an embodiment of the present disclosure. The display interface includes a target page corresponding to target information which is constructed based on a target page element, the target page element being obtained from hierarchical page elements according to an association with the target information, after the target information is obtained from an external storage device.

### BRIEF DESCRIPTION OF THE DRAWINGS

In order to describe the technical solutions in the embodiments of the present application or the conventional technology more clearly, the following will briefly introduce the accompanying drawings required for describing the embodiments or the conventional technology. Apparently, the accompanying drawings in the following description are merely embodiments of the present disclosure, and for a person of ordinary skill in the art, other drawings can be obtained based on the disclosed drawings without creative efforts.

FIG. 1 is a schematic diagram of a configuration of a computer device in some embodiments.

FIG. 2 is a flowchart of a page display method in some embodiments.

FIG. 3 is a flowchart of a page display method in some other embodiments.

FIG. 4 is a schematic diagram of displaying a target page in some embodiments.

FIG. 5 is a schematic diagram of displaying a target page in some other embodiments.

FIG. 6 is a flowchart of a page display method in some other embodiments.

FIG. 7 is a flowchart of a page display method in some other embodiments.

FIG. 8 is a flowchart of a page display method in some other embodiments.

FIG. 9 is a schematic diagram of a structure of a page display system in some embodiments.

FIG. 10 is a flowchart of a page display method in other embodiments.

FIG. 11 is a schematic diagram of a process for medical staff to input diagnosis and treatment data into a system in some embodiments.

FIG. 12 is a schematic diagram of a process for medical staff to input diagnosis and treatment data into a system in other embodiments.

FIG. 13 is a schematic diagram of a structure of a page display device in some embodiments.

### DETAILED DESCRIPTION OF THE EMBODIMENTS

To make the purposes, features, and advantages of the present disclosure more clearly understood, detailed explanations of specific embodiments of the present disclosure are provided below in conjunction with the accompanying drawings. It should be understood that the specific embodiments described herein are only used to explain the present disclosure and are not used to limit the present disclosure.

The serial numbers assigned to the components in this article, such as “first”, “second”, etc., are only used to distinguish the objects described and do not have any order or technical meaning.

First, before specifically introducing the technical solutions of the disclosed embodiments of the present disclosure, background technologies or technical evolution context related to embodiments of the present disclosure is introduced. In hospitals, when the number of patients increases and each patient's consultation time becomes longer, recording patient information and medical data becomes a tedious and heavy task for medical staff. At present, most hospitals employ informatization systems, and medical staff can input information through web pages on terminals and synchronize the input information to the hospital's system. However, due to the excessive types of diagnosis and treatment data and the deep level of diagnosis and treatment data in the data structure (i.e., the diagnosis and treatment data can be divided into multiple levels of data according to departments and diagnosis and treatment cycles), the page entry and jump are more complicated during the entry process. The dense page entries and frequent page jumps in the process of inputting diagnosis and treatment data do not reduce the burden on medical staff. All that has changed is that the input method has changed from paper to Internet. It can be seen that for medical staff, the current operation of inputting information is complicated and inefficient. In this regard, the present disclosure provides a page display method that can improve the operating efficiency.

The technical solution of the present disclosure and how the technical solution of the present disclosure solves the technical problem are described in detail below with specific embodiments.

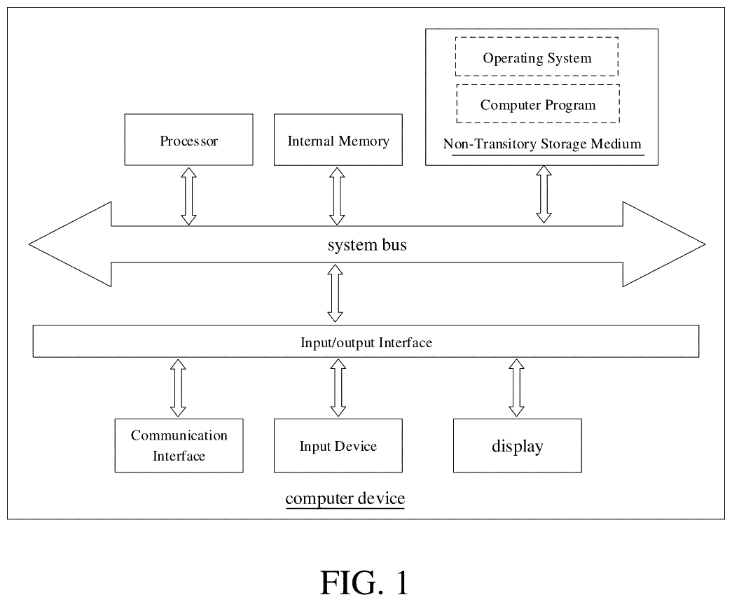

The page display method provided in the present disclosure can be applied to a computer device, which can be a terminal, and the terminal can be, but is not limited to, an industrial computer, a laptop, a smart phone, a tablet computer, and a portable wearable device. The configuration of the computer device can be shown in FIG. 1. The computer device includes a processor, a memory, a communication interface, a display screen, and an input device connected via a system bus. The processor of the computer device is configured to provide computing and control capabilities. The memory of the computer device includes a non-transitory storage medium and an internal memory. The non-transitory storage medium stores an operating system and a computer program. The internal memory provides an environment for the operation of the operating system and the computer program in the non-transitory storage medium. The communication interface of the computer device is configured to communicate with an external terminal in a wired or wireless manner, and the wireless manner can be implemented via Wi-Fi (wireless network communication technology), a mobile cellular network, NFC (Near Field Communication, near field communication) or other technologies. When the computer program is executed by the processor, a page display method is performed. The display screen of the computer device can be a liquid crystal display screen or an electronic ink display screen, and the input device of the computer device can be a touch layer covering the display screen, or a button, a trackball or a touchpad provided on the computer device housing, or an external keyboard, touchpad or mouse.

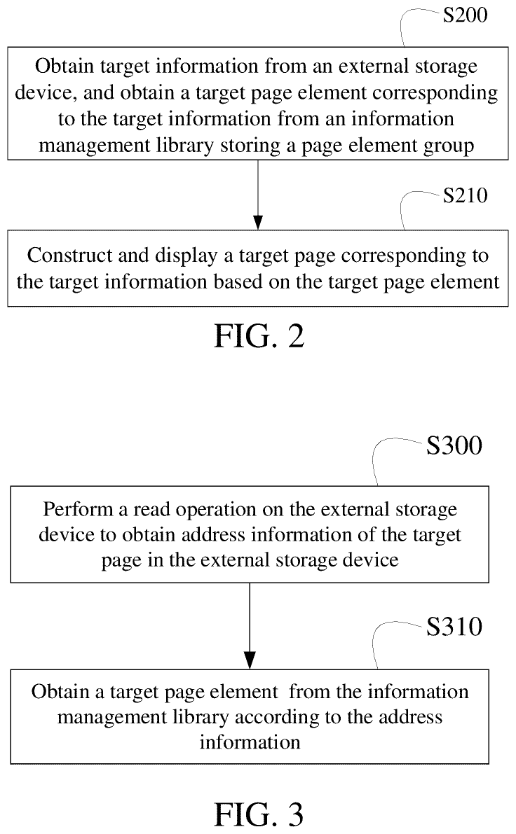

In some embodiments, as shown in FIG. 2, a page display method is provided. The method is applied to a terminal as an example in this embodiment. In this embodiment, the method includes the following steps S200 to S210.

In the step S200, target information is obtained from an external storage device, and a target page element corresponding to the target information is obtained from an information management library storing a page element group. The page element group includes hierarchical page elements.

The external storage device may be a device that can be communicatively connected to the terminal and is configured to store target information. The communication between the external storage device and the terminal may be achieved via NFC or Bluetooth, which is not limited in this embodiment. The external storage device may be a memory card, a smart phone, a tablet computer, etc. There may be multiple external storage devices, and different external storage devices store different target information. The type of external storage device and the format of the target information stored in the external storage device are not limited in this embodiment, as long as its function can be achieved.

The terminal obtains the target information from the external storage device. Exemplarily, the target information can be read by the terminal from the external storage device, or sent to the terminal by the external storage device. The target information can be the address, index, and link of the page to be displayed. The specific content of the target information is not limited in this embodiment as long as its function can be achieved.

In an optional embodiment where the external storage device is a memory card and the terminal is a smart phone, the smart phone can read the target information in the memory card when placed close to the memory card. If the external storage device is an IC card and the terminal includes a card reader, when the IC card is inserted into the card reader, the terminal can read the target information in the IC card. If the external storage device includes a barcode or a QR code, the terminal obtains the target information by scanning the barcode or the QR code. If the external storage device is a smart phone and the terminal is a tablet computer, the target information can be sent to the tablet computer by the smart phone.

The information management library may be pre-stored in the memory of the terminal. The information management library stores a page element group, which includes hierarchical page elements. Page elements refer to the contents displayed on the page, such as text, pictures, audio, animation, video, etc. The page element group includes a plurality of page elements, and the plurality of page elements have a hierarchical structure. Exemplarily, the page element group includes a first level and a second level under the first level, the first level includes a plurality of page elements, and the second level also includes a plurality of page elements. The page elements on the second level are obtained by triggering a page element on the first level.

The page elements included in the information management library have corresponding identifiers, such as an index, an address or a link. After the terminal obtains the target information from the external storage device, it searches the information management library for the target page element corresponding to the target information based on the target information. For example, it searches the information management library for an identifier whose similarity to the target information is greater than a preset threshold, and determines the page element corresponding to the identifier as the target page element. The target page element may refer to a page element at an intermediate level in the hierarchical structure of the page element group, or may refer to a page element at a bottom level in the hierarchical structure of the page element group. The target page element may include a plurality of page elements.

In the step S210, a target page corresponding to the target information is constructed and displayed based on the target page element.

After the terminal obtains the target page element, it constructs the target page element according to a preset layout to obtain the target page corresponding to the target information. The preset layout can be predetermined by the staff. In other words, after obtaining the target page element, the terminal arranges each page element of the target page element on the corresponding position according to the preset layout to form the target page. The terminal includes a display screen, and after obtaining the target page, the terminal displays the target page on the interface of the display screen.

According to the page display method provided in the embodiments of the present disclosure, the target information is obtained from the external storage device, and the target page element corresponding to the target information is obtained from the information management library storing the page element group. The page element group includes hierarchical page elements. The target page corresponding to the target information is constructed and displayed based on the target page element. In this embodiment, when the target page needs to be displayed, the target information corresponding to the target page is directly obtained from the external storage device, and the target page element corresponding to the target page can be directly obtained from the information management library according to the target information, so that the target page is constructed and displayed based on the target page element. In this way, when displaying the target page, it is not necessary to first obtain the page elements corresponding to the upper level or multiple upper levels of the target page according to the hierarchical structure for display, and display the target page only after triggering a page of the upper level. In other words, there is no need to perform a plurality of page jump operations, which can improve the efficiency of displaying the target page, and make the operation of displaying the target page more convenient and quicker.

In some embodiments, FIG. 3 shows an implementation method for obtaining the target information from the external storage device and obtaining the target page element corresponding to the target information from the information management library storing a page element group. The implementation method includes the following steps S300 to S310.

In the step S300, a read operation is performed on the external storage device to obtain address information of the target page in the external storage device.

The target information may include address information of the target page to be displayed, and the address information corresponding to the target page is stored in a certain external storage device. The terminal performs the read operation on the corresponding external storage device to obtain the address information in the external storage device. The terminal establishes a connection with the external storage device via NFC or Bluetooth, and reads the address information in the external storage device after the connection is successfully established.

When the page display method is applied to the medical field, the target page to be displayed may be a page of thrombolytic drugs during thrombolytic therapy in the neurology department. The neurology department may have a plurality of external storage devices, such as an external storage device corresponding to the patient's identity information, an external storage device corresponding to the time of administration of the patient's first dose of the drug, and an external storage device corresponding to the thrombolytic drugs during thrombolytic therapy. The terminal establishes a connection with the external storage device corresponding to the thrombolytic drugs during thrombolytic therapy and reads the target information, i.e., the address information, from the external storage device.

In the step S310, a target page element is obtained from the information management library according to the address information.

After obtaining the address information, the terminal searches the information management library for the page element corresponding to the address information according to the address information to obtain the target page element. The information management library includes reference address information corresponding to the page element. The terminal compares the obtained address information with the reference address information in the information management library, and determines the page element corresponding to the reference address information in the information management library whose similarity to the obtained address information is greater than or equal to a preset threshold as the target page element.

In this embodiment, the target information obtained from the external storage device is address information, and the corresponding target page element can be directly obtained from the information management library according to the address information, which can improve the efficiency of obtaining the target page element so as to improve the efficiency of displaying the target page.

In some embodiments, the target page element includes display parameters and first default values of the display parameters. The target page element may include a plurality of page elements, each of which includes display parameters to be displayed and parameter values corresponding to the display parameters, i.e., the first default values. The first default values are parameter values pre-set by the staff for the display parameters.

In an optional embodiment, when the page display method is applied to the medical field. Usually, the diagnosis and treatment data can be divided into three levels. The first level includes the diagnosis and treatment cycle. Each department of the hospital is responsible for diagnosis or examination and other services in different diagnosis and treatment stages. For example, before a stroke patient undergoes thrombolytic treatment, the doctor in the neurology department gives thrombolytic drugs. The second level includes the diagnosis and treatment information items that need to be filled in by medical staff in each department. For example, thrombolytic drugs and the time of first dose administration in the neurology department are both items, and each diagnosis and treatment information item has specific sub-items that need to be filled in. The third level includes specific sub-items that need to be filled in. For example, the sub-items that need to be filled in under thrombolytic drugs include the specific drugs, the drug dose, and the dosage unit. The indexes of each level are stored in the external storage device. For example, the index of a second-level thrombolytic treatment in the neurology department is 104, and the index of a third-level sub-item that need to be filled in under the diagnosis and treatment information item is 10405.

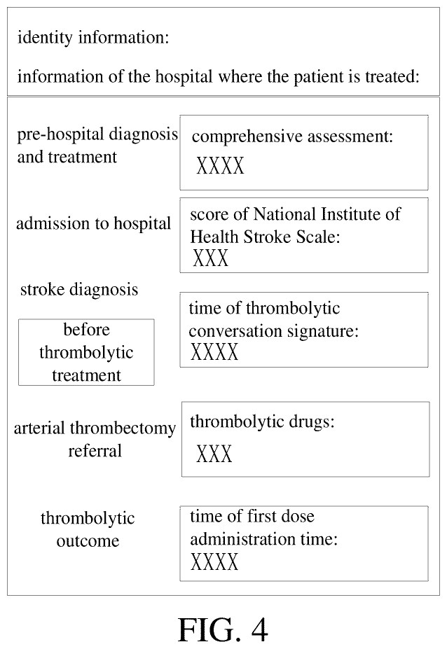

When the target information obtained by the terminal from the external storage device is the index of the second-level neurology thrombolytic therapy, FIG. 4 shows a target page where the display parameters in the target page include the comprehensive assessment, the score of National Institute of Health Stroke Scale (NIHSS), the time of thrombolytic conversation signature, thrombolytic drugs, and the time of first dose administration time. The first default values are displayed under the corresponding display parameters. As shown in FIG. 4, the target page element can also include the patient's identity information, the information of the hospital where the patient is treated, and other display parameters related to, for example, pre-hospital diagnosis and treatment, admission to hospital, examination and testing, stroke diagnosis, before-thrombolytic treatment, arterial thrombectomy referral, and thrombolytic outcome.

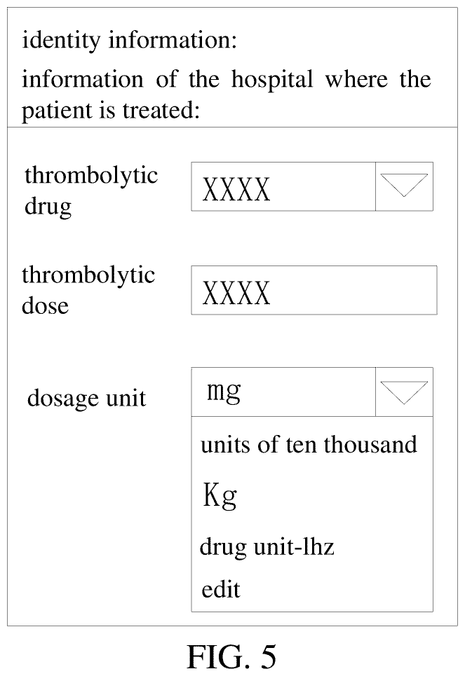

When the target information obtained by the terminal from the external storage device is the index of the sub-item (thrombolytic drugs) that needs to be filled in under the third-level diagnosis and treatment information item, the corresponding target page is shown in FIG. 5. The display parameters in the target page includes the thrombolytic drug, the thrombolytic dose and the dosage unit. The display box behind each display parameter contains the first default value of the display parameter. The display box behind the display parameter includes a drop-down control. By operating the drop-down control, a drop-down menu can be displayed. The drop-down menu includes other parameter values of the display parameter, as well as an edit control. By triggering the edit control, the user can input a parameter value by himself. As shown in FIG. 5, the display box behind the dosage unit contains the first default value of mg, and the drop-down menu includes other parameter values, such as units of ten thousand, kg, drug unit-lhz and the edit control.

In the case where the target page element includes display parameters and first default values of the display parameters, the implementation method for constructing and displaying the target page corresponding to the target information based on the target page element includes constructing and displaying the target page corresponding to the target information based on the display parameters and the first default values.

After obtaining the display parameters and the first default values, the terminal constructs the display parameters and the first default values according to a preset layout to obtain a target page. The display parameters and the first default values are arranged correspondingly according to the preset layout. After obtaining the target page, the terminal displays the target page on the interface of the display screen.

In this embodiment, the target page element obtained includes the display parameters and the first default values of the display parameters, so that the displayed target page includes not only the display parameters but also the first default values of the display parameters, and the user does not need to input it again, which can improve the efficiency and practicality of the page display method. In addition, the first default values of the display parameters can be edited, which is convenient for the user to modify, making the page display method more practical.

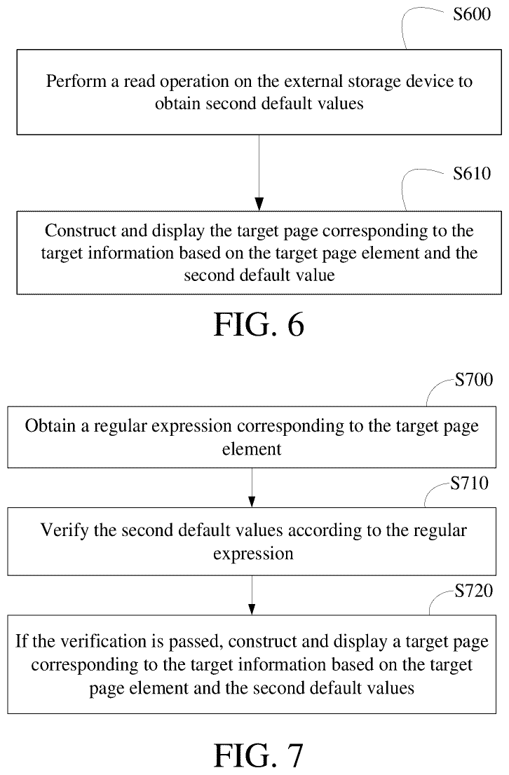

In some embodiments, as shown in FIG. 6, the page display method further includes the following step S600.

In the step S600, a read operation is performed on the external storage device to obtain second default values.

The second default values refer to default values corresponding to the display parameters. The second default values are stored in the external storage device. The terminal obtains the second default values by performing a read operation on the external storage device. The description of the second default values can refer to the description of the first default values in the above embodiment, which will not be repeated here.

In an optional embodiment, after establishing a communication connection with the external storage device, the terminal may first read the target information from the external storage device and obtain the target page element corresponding to the target information from the information management library, and then read the second default values from the external storage device.

In another optional embodiment, after establishing a communication connection with the external storage device, the terminal directly reads the target information and the second default values from the external storage device.

In this case, the implementation method for constructing and displaying the target page corresponding to the target information based on the target page element includes the following step S610.

In the step S610, the target page corresponding to the target information is constructed and displayed based on the target page element and the second default values.

The target page element obtained by the terminal includes the display parameters. After reading the second default values from the external storage device, the terminal constructs the target page element and the second default values, i.e., the display parameters and the second default values, according to the preset layout, to obtain the target page. The terminal displays the target page on the interface of the display screen.

In this embodiment, the second default values of the display parameters are stored in an external storage device. The second default values are obtained from the external storage device, and the target page is constructed and displayed based on the second default values and the target page element. The target page displayed in this way includes not only the target page element (i.e., display parameters), but also the first default values of the display parameters, without the need for the user's input operation, which can improve the efficiency and practicality of the page display method. In addition, the second default values can be read at the same time as the target information is read, which can improve the efficiency of obtaining the second default values, thereby improving the efficiency of constructing and displaying the target page.

In an optional embodiment, when the external storage device is an IC card, there are usually 15 sectors in the IC card, each sector has 4 blocks, and each block can store 16 bytes of data, i.e., 2 long data. The way for storing the target information in the IC card can be that the address, manufacturer information, and key of the IC card are stored in the first few (usually 3) sectors of the IC card, the index of the diagnosis and treatment stage is stored in the first 8 bytes of the 0th block of the 4th sector of the IC card in the format of long, and the diagnosis and treatment information items under the diagnosis and treatment stage are stored in the last 8 bytes of the 0th block of the 4th sector of the IC card in the format of long. The second default values can be stored in the form of ASCII (American Standard Code for Information Interchange) code value in the 5th sector of the IC card.

In some embodiments, as shown in FIG. 7, the implementation method for constructing and displaying a target page corresponding to target information based on the target page element and the second default value includes the following steps S700 to S720.

In the step S700, a regular expression corresponding to the target page element is obtained.

The regular expression can be a text pre-set by the staff to retrieve the format and content of the parameter values of the display parameters in the target page element. Different display parameters have different corresponding parameter values, so different regular expressions are used. The number of regular expressions obtained can be one or more. After obtaining the target page element corresponding to the target information, the terminal will obtain the regular expression corresponding to the target page element in the memory.

In the step S710, the second default values are verified according to the regular expression.

After obtaining the regular expression of the target page element, the terminal uses the regular expression to validate the second default values to determine whether the second default values are accurate. For example, each display parameter in the target page element may correspond to a regular expression, or several display parameters may share a regular expression.

If the display parameters include the thrombolytic drugs, the thrombolytic dosage, and the dosage units, each display parameter corresponds to a regular expression. When the second default value of the thrombolytic dosage is verified using the regular expression, if the second default value of the thrombolytic dosage is a number, it means that the second default value of the thrombolytic dosage has passed the verification. If the second default value of the thrombolytic dosage is a letter or a symbol, it means that the second default value of the thrombolytic dosage has not passed the verification.

In the step S720, if the verification is passed, a target page corresponding to the target information is constructed and displayed based on the target page element and the second default values.

If the terminal validates the second default values based on the regular expression and determines that all the second default values have passed the verification, the target page element and the second default values, i.e., the display parameters and the second default values, are constructed according to the preset layout to obtain the target page, and the target page is displayed on the interface of the display screen. If the terminal validates the second default values based on the regular expression and determines that there is at least one second default value that has not passed the verification, the second default value that has not passed the verification may not be displayed in the target page. A prompt display box may pop up to prompt the user that there is an abnormality in the second default value of a specific display parameter.

In this embodiment, after obtaining the second default values, the regular expression corresponding to the target page element (display parameters) is first obtained, and the second default values are verified using the regular expression. After the verification is passed, the target page corresponding to the target information is constructed and displayed based on the target page element and the second default values. In this way, the accuracy of the displayed second default values can be guaranteed, making the page display method more practical.

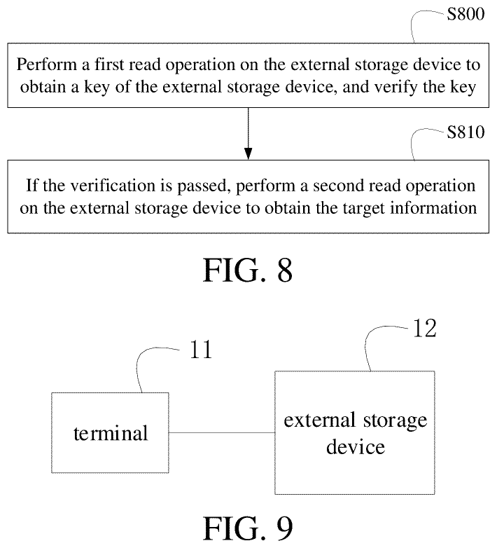

In some embodiments, as shown in FIG. 8, the implementation method for obtaining the target information from the external storage device, and obtaining the target page element corresponding to the target information from the information management library storing the page element group includes the steps S800 to S810.

In the step S800, a first read operation is performed on the external storage device to obtain a key of the external storage device, and the key is verified.

The key of the external storage device is stored in the external storage device. When the target page needs to be displayed, the terminal connects to the corresponding external storage device, performs the first read operation on the external storage device to obtain the key of the external storage device after the connection is established, and verifies the key.

In an optional embodiment, a corresponding default key is stored in the terminal. After reading the key of the external storage device, the terminal verifies the key of the external storage device according to the default key, i.e., compares the default key and the key of the external storage device to determine whether the default key and the key of the external storage device are the same. If they are the same, it means the verification is passed. If they are not the same, it means the verification fails.

In the step S810, if the verification is passed, a second read operation is performed on the external storage device to obtain the target information.

If the terminal verifies the key of the external storage device and determines that the verification is passed, it means that the external storage device is the required external storage device, and a communication connection between the terminal and the external storage device is successfully established. A second read operation is performed on the external storage device to obtain the target information.

If the terminal verifies the key of the external storage device and determines that the verification fails, it means that the external storage device is not the required external storage device, and the communication connection between the terminal and the external storage device is disconnected.

In an optional embodiment, the page display method is applied to the medical field, and there is a first external storage device in the first hospital and a second external storage device in the second hospital. The medical staff of the first hospital use the terminal to establish a connection with the second external storage device via NFC, read the key of the second external storage device, and verify the key of the second storage device. The external storage device required by the medical staff of the first hospital should be the first external storage device, so the verification fails, and the connection between the terminal and the second external storage device is disconnected.

In this embodiment, when obtaining the target information from the external storage device, the key of the external storage device is first obtained and then verified. After the verification is passed, the target information is obtained from the external storage device. This ensures that the obtained target information is accurate, thereby ensuring the accuracy of the displayed target page, making the page display method more practical.

In some embodiments, after the target page information is displayed on the display interface of the terminal, the user performs an input operation on the target page. In this case, the page display method further includes storing input information in response to the user's input operation on the target page.

After the target page is displayed on the interface of the terminal, the user modifies the default value corresponding to the target parameter on the target page, and/or inputs the parameter value corresponding to the target parameter. The terminal responds to the user's input operation (modification operation) and stores the default value modified by the user and/or the input parameter value, i.e., stores the default value and the input parameter value in the information management library.

In this embodiment, the information input by the user on the target page is stored, which is convenient for the user to search and use later and can improve the practicality of the page display method.

In some embodiments, as shown in FIG. 9, the present disclosure provides a page display system, which includes a terminal 11 and an external storage device 12. The external storage device 12 is configured to store target information. The terminal 12 is configured to perform the page display method provided in the above embodiments.

Regarding the terminal 11 and the external storage device 12, references can be made to the specific descriptions in the above embodiments, which will not be repeated herein.

The page display system provided in this embodiment includes a terminal, and the terminal is configured to perform the page display method provided in the above embodiments. The page display system has all the beneficial effects of the page display method, which will not be repeated here.

In some embodiments, an embodiment of the present disclosure provides a display interface. The display interface includes a target page. The target page corresponding to the target information is constructed based on the target page element. After the target information is obtained from the external storage device, the target page element is obtained from the hierarchical page elements according to an association with the target information.

The display interface may be an interface displayed on a display screen of the terminal. After the terminal obtains the target information from the external storage device, one or more page elements associated with the target information are obtained from the information management library based on the target information, as the target page element, and the target page element are displayed on the display interface according to a preset layout. The target page element can form the target page. The information management library stores a page element group, which includes hierarchical page elements.

Obtaining the target information from the external storage device and obtaining one or more page elements from the information management library according to the target information can be understood by referring to the specific description in the above embodiments, which will not be repeated herein.

In this embodiment, one or more page elements on the display interface can be directly obtained from the information management library according to the target information obtained from the external storage device, which can improve the efficiency of obtaining one or more page elements and improve the efficiency of displaying one or more page elements.

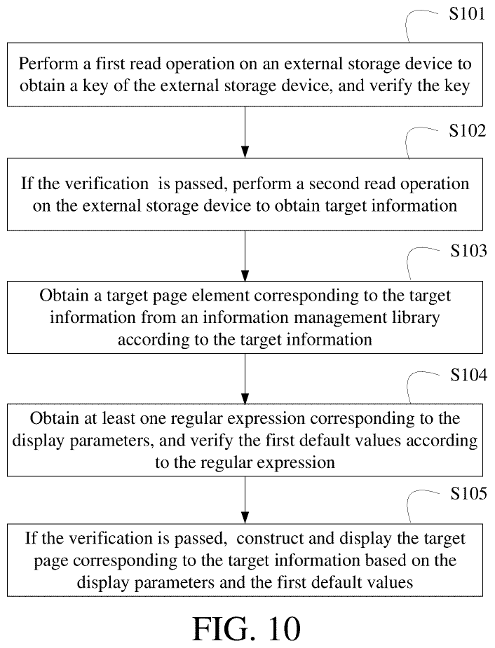

Referring to FIG. 10, an embodiment of the present disclosure provides a page display method. The method includes the steps S101 to S105.

In the step S101, a first read operation is performed on an external storage device to obtain a key of the external storage device, and the key is verified.

In the step S102, if the verification is passed, a second read operation is performed on the external storage device to obtain target information.

In the step S103, a target page element corresponding to the target information is obtained from an information management library according to the target information. The target page element includes display parameters and first default values of the display parameters. The information management library stores a page element group. The page element group includes hierarchical page elements.

In the step S104, at least one regular expression corresponding to the display parameters is obtained, and the first default values are verified according to the regular expression.

In the step S105, if the verification is passed, the target page corresponding to the target information is constructed and displayed based on the display parameters and the first default values.

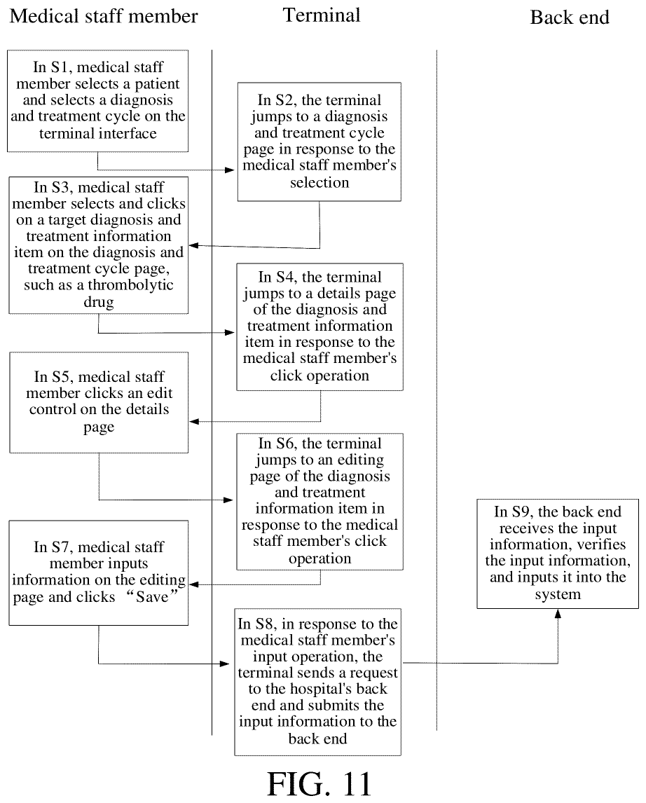

In some embodiments, a typical process of medical staff member inputting diagnosis and treatment data into the system is shown in FIG. 11. In the step S1, medical staff member selects a patient and selects a diagnosis and treatment cycle on the terminal interface. In the step S2, the terminal jumps to a diagnosis and treatment cycle page in response to the medical staff member's selection. In the step S3, medical staff member selects and clicks on a target diagnosis and treatment information item on the diagnosis and treatment cycle page, such as thrombolytic drugs. In the step S4, the terminal jumps to a details page of the diagnosis and treatment information item in response to the medical staff member's click operation. In the step S5, medical staff member clicks an edit control on the details page. In the step S6, the terminal jumps to an editing page of the diagnosis and treatment information item in response to the medical staff member's click operation. In the step S7, medical staff member inputs information on the editing page and clicks “Save”. In the step S8, in response to the medical staff member's input operation, the terminal sends a request to the hospital's back end and submits the input information to the back end. In the step S9, the back end receives the input information, verifies the input information, and inputs it into the system.

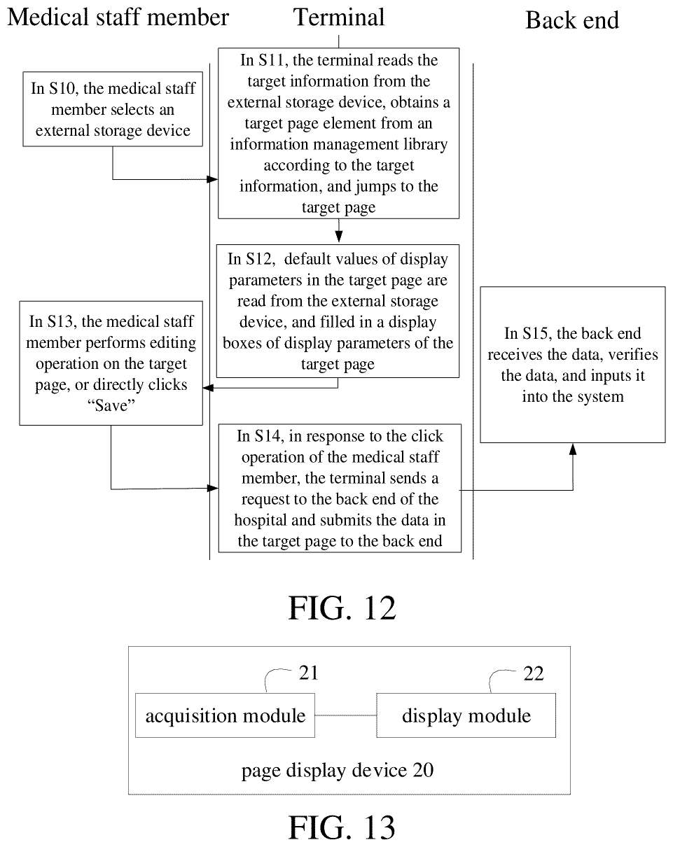

When the page display method provided by the present disclosure is applied, the flowchart of medical staff member inputting the medical treatment data into the system is shown in FIG. 12. In the step S10, the medical staff member selects an external storage device. In the step S11, the terminal reads the target information from the external storage device, obtains a target page element from an information management library according to the target information, and jumps to the target page. In the step S12, default values of display parameters in the target page are read from the external storage device, and filled in display boxes of display parameters of the target page. In the step S13, the medical staff member performs editing operation on the target page, or directly clicks “Save”. In the step S14, in response to the click operation of the medical staff member, the terminal sends a request to the back end of the hospital and submits the data in the target page to the back end. In the step S15, the back end receives the data, verifies the data, and inputs it into the system.

It can be understood that, although the operations in the flowcharts involved in the above embodiments are displayed in sequence according to the arrows, these operations are not necessarily executed sequentially in the order indicated by the arrows. The operations are not strictly executed in the order unless explicitly stated herein. The operations may be executed in other orders. Moreover, at least a part of the operations in the flowcharts involved in the above embodiments may include a plurality of operations or a plurality of stages. The plurality of operations or stages are not necessarily performed at a same time, but may be performed at different times. These operations or stages are also not performed necessarily in order, but may be performed alternately or alternatively with other operations or at least a part of the operations or stages in the other operations.

Based on the same inventive concept, the embodiment of the present disclosure also provides a page display device for performing the page display method described above. The solution for solving the problem provided by the page display device is similar to the solution of the above method, so the specific limitations in one or more page display device embodiments provided below can refer to the limitations on the page display method above, and will not be repeated here.

In some embodiments, as shown in FIG. 13, a page display device 20 is provided. The page display device 20 includes an acquisition module 21 and a display module 22.

The acquisition module 21 is configured to obtain target information from an external storage device, and obtain a target page element corresponding to the target information from an information management library storing a page element group. The page element group includes hierarchical page elements.

The display module 22 is configured to construct and display a target page corresponding to the target information based on the target page element.

In some embodiments, the acquisition module 21 includes an address acquisition unit and an element acquisition unit. The address acquisition unit is configured to perform a read operation on the external storage device to obtain address information of the target page in the external storage device. The element acquisition unit is configured to obtain the target page element from the information management library according to the address information.

In some embodiments, the display module 22 is specifically configured to construct and display a target page corresponding to the target information based on the display parameters and the first default values.

In some embodiments, the page display device 20 further includes a reading module. The reading module is configured to perform a read operation on the external storage device to obtain second default values. The display module 22 is also configured to construct and display the target page corresponding to the target information based on the target page element and the second default values.

In some embodiments, the display module 22 includes a regular expression acquisition unit and the verification unit. The regular expression acquisition unit is configured to obtain a regular expression corresponding to the target page element. The verification unit is configured to verify the second default values according to the regular expression, and if the verification is passed, construct and display the target page corresponding to the target information based on the target page element and the second default values.

In some embodiments, the acquisition module 21 is specifically configured to perform a first read operation on the external storage device to obtain a key of the external storage device, verify the key, and if the verification is passed, perform a second read operation on the external storage device to obtain the target information.

The above-mentioned page display device may be implemented through software, hardware, and a combination thereof. The above modules may be embedded in or independent from a processor in a computing device, and may also be stored in a storage device of the computing device in a software form, so that the processor may call and execute the operations corresponding to each of the above modules.

In some embodiments, a computer device is provided, and it should be understood by those skilled in the art that the configuration shown in FIG. 1 is a block diagram showing only part of the configuration associated with the solutions of the present disclosure, but not intend to limit the computer device to which the solutions of the present disclosure are applied, and that the particular computer device may include more or less components than those shown in the drawings, or may combine with certain components, or may have different component arrangements.

In some embodiments, a computer device is provided, including a memory and a processor. A computer program is stored in the memory. The processor, when executing the computer program, performs a page display method, which includes: obtaining target information from an external storage device, and obtaining a target page element corresponding to the target information from an information management library storing a page element group, the page element group including hierarchical page elements, and constructing and displaying a target page corresponding to the target information based on the target page element.

In some embodiments, the page display method further includes: performing a read operation on the external storage device to obtain address information of the target page in the external storage device, and obtaining the target page element from the information management library according to the address information.

In some embodiments, the page display method further includes: constructing and displaying the target page corresponding to the target information based on the display parameters and the first default values.

In some embodiments, the page display method further includes: performing a read operation on the external storage device to obtain second default values, and constructing and displaying the target page corresponding to the target information based on the target page element and the second default values.

In some embodiments, the page display method further includes: obtaining a regular expression corresponding to the target page element, verifying the second default values according to the regular expression, and if the verification is passed, constructing and displaying the target page corresponding to the target information based on the target page element and the second default values.

In some embodiments, the page display method further includes: performing a first read operation on the external storage device to obtain a key of the external storage device and verifying the key, and if the verification is passed, performing a second read operation on the external storage device to obtain the target information.

In some embodiments, a computer readable storage medium is provided, on which a computer program is stored. The processor, when executing the computer program, performs a page display method, which includes: obtaining the target information from an external storage device, and obtaining a target page element corresponding to the target information from an information management library storing a page element group, the page element group including hierarchical page elements, and constructing and displaying a target page corresponding to the target information based on the target page element.

In some embodiments, the page display method further includes: performing a read operation on the external storage device to obtain address information of the target page in the external storage device, and obtaining the target page element from the information management library according to the address information.

In some embodiments, the page display method further includes: constructing and displaying the target page corresponding to the target information based on the display parameters and the first default values.

In some embodiments, the page display method further includes: performing a read operation on the external storage device to obtain second default values, and constructing and displaying the target page corresponding to the target information based on the target page element and the second default values.

In some embodiments, the page display method further includes: obtaining a regular expression corresponding to the target page element, verifying the second default values according to the regular expression, and if the verification is passed, constructing and displaying the target page corresponding to the target information based on the target page element and the second default values.

In some embodiments, the page display method further includes: performing a first read operation on the external storage device to obtain a key of the external storage device, and verifying the key, and if the verification is passed, performing a second read operation on the external storage device to obtain the target information.

In some embodiments, a computer program product is provided, including a computer program. The processor, when executing the computer program, performs a page display method, which includes: obtaining target information from an external storage device, and obtaining a target page element corresponding to the target information from an information management library storing a page element group, the page element group including hierarchical page elements, and constructing and displaying a target page corresponding to the target information based on the target page element.

In some embodiments, the page display method further includes: performing a read operation on the external storage device to obtain address information of the target page in the external storage device, and obtaining the target page element from the information management library according to the address information.

In some embodiments, the page display method further includes: constructing and displaying the target page corresponding to the target information based on the display parameters and the first default values.

In some embodiments, the page display method further includes: performing a read operation on the external storage device to obtain second default values, constructing and displaying the target page corresponding to the target information based on the target page element and the second default values.

In some embodiments, the page display method further includes: obtaining a regular expression corresponding to the target page element, verifying the second default values according to the regular expression, and if the verification is passed, constructing and displaying the target page corresponding to the target information based on the target page element and the second default values.

In some embodiments, the page display method further includes: performing a first read operation on the external storage device to obtain a key of the external storage device, and verifying the key, and if the verification is passed, performing a second read operation on the external storage device to obtain the target information.

Those of ordinary skill in the art can understand that all or part of the processes in the methods of the above embodiments can be completed by instructing relevant hardware through a computer program. The computer program can be stored in a non-transitory computer-readable storage. In the media, when executed, the computer program may include the processes of the above method embodiments. Any reference to memory, database or other media used in the embodiments provided in the present disclosure may include at least one of non-transitory and transitory memory. Non-transitory memory can include read-only memory (ROM), magnetic tape, floppy disk, flash memory, optical memory, high-density embedded non-transitory memory, resistive memory (ReRAM), magnetic variable memory (Magnetoresistive Random Access Memory (MRAM), ferroelectric memory (Ferroelectric Random Access Memory, FRAM), phase change memory (Phase Change Memory, PCM), graphene memory, etc. Transitory memory may include random access memory (Random Access Memory, RAM) or external cache memory, etc. By way of illustration and not limitation, RAM can be in many forms, such as static random access memory (Static Random Access Memory, SRAM) or dynamic random access memory (Dynamic Random Access Memory, DRAM). The databases involved in the various embodiments provided in the present disclosure may include at least one of a relational database and a non-relational database. Non-relational databases may include blockchain-based distributed databases, etc., but are not limited thereto. The processors involved in the various embodiments provided in the present disclosure may be general-purpose processors, central processing units, graphics processors, digital signal processors, programmable logic devices, quantum computing-based data processing logic devices, etc., and are not limited to this.

The technical features of the above embodiments can be randomly combined. To simplify the description, not all possible combinations of the technical features in the above embodiments are described. However, as long as there is no contradiction in the combination of these technical features, all the combinations should be considered to be included within the scope of this specification.

The above-described embodiments only illustrate several embodiments of the present disclosure, and the descriptions of which are relatively specific and detailed, but should not be construed as limiting the scope of the patent disclosure. It should be noted that, for those of ordinary skill in the art, several modifications and improvements can be made without departing from the concept of the present disclosure, and these all fall within the protection scope of the present disclosure. Therefore, the protection scope of the present disclosure should be determined by the appended claims.

What is claimed is:

1. A page display method, comprising:
obtaining target information from an external storage device, and obtaining a target page element corresponding to the target information from an information management library storing a page element group, the page element group comprising hierarchical page elements; and
constructing and display a target page corresponding to the target information based on the target page element.

2. The page display method according to claim 1, wherein obtaining the target information from the external storage device, and obtaining the target page element corresponding to the target information from the information management library storing the page element group comprises:
performing a read operation on the external storage device to obtain address information of the target page in the external storage device; and
obtaining the target page element from the information management library according to the address information.

3. The page display method according to claim 2, wherein obtaining the target page element from the information management library according to the address information comprises:
determining the page element corresponding to reference address information in the information management library whose similarity with obtained address information is greater than or equal to a preset threshold as the target page element.

4. The page display method according to claim 1, wherein the target page element comprises display parameters and first default values of the display parameters, and constructing and displaying the target page corresponding to the target information based on the target page element comprises:
constructing and displaying the target page corresponding to the target information based on the display parameters and the first default values.

5. The page display method according to claim 1, further comprising:
performing a read operation on the external storage device to obtain second default values,
wherein constructing and displaying the target page corresponding to the target information based on the target page element comprises:
constructing and displaying the target page corresponding to the target information based on the target page element and the second default values.

6. The page display method according to claim 5, wherein constructing and displaying the target page corresponding to the target information based on the target page element and the second default values comprises:
obtaining a regular expression corresponding to the target page element;
verifying the second default values according to the regular expression; and
if the verification is passed, constructing and displaying the target page corresponding to the target information based on the target page element and the second default values.

7. The page display method according to claim 1, wherein obtaining the target information from the external storage device comprises:
performing a first read operation on the external storage device to obtain a key of the external storage device, and verifying the key; and
if the verification is passed, performing a second read operation on the external storage device to obtain the target information.

8. A page display system, comprising a terminal and an external storage device, the external storage device being configured to store target information, wherein the terminal is configured to perform a page display method which comprises:
obtaining the target information from an external storage device, and obtaining a target page element corresponding to the target information from an information management library storing a page element group, the page element group comprising hierarchical page elements; and
constructing and displaying a target page corresponding to the target information based on the target page element.

9. The page display system according to claim 8, wherein obtaining the target information from the external storage device, and obtaining the target page element corresponding to the target information from the information management library storing the page element group comprises:
performing a read operation on the external storage device to obtain address information of the target page in the external storage device; and
obtaining the target page element from the information management library according to the address information.

10. The page display system according to claim 9, wherein obtaining the target page element from the information management library according to the address information comprises:
determining the page element corresponding to reference address information in the information management library whose similarity with obtained address information is greater than or equal to a preset threshold as the target page element.

11. The page display system according to claim 8, wherein the target page element comprises display parameters and first default values of the display parameters, and constructing and displaying the target page corresponding to the target information based on the target page element comprises:
constructing and displaying the target page corresponding to the target information based on the display parameters and the first default values.

12. The page display system according to claim 8, wherein the page display method further comprises:
performing a read operation on the external storage device to obtain second default values; and
constructing and displaying the target page corresponding to the target information based on the target page element comprises:
constructing and displaying the target page corresponding to the target information based on the target page element and the second default values.

13. The page display system according to claim 12, wherein constructing and displaying the target page corresponding to the target information based on the target page element and the second default values comprises:
obtaining a regular expression corresponding to the target page element;
verifying the second default values according to the regular expression; and
if the verification is passed, constructing and displaying the target page corresponding to the target information based on the target page element and the second default values.

14. The page display system according to claim 8, wherein obtaining the target information from the external storage device comprises:
performing a first read operation on the external storage device to obtain a key of the external storage device, and verifying the key; and
if the verification is passed, performing a second read operation on the external storage device to obtain the target information.

15. The page display system according to claim 8, wherein the terminal and the external storage device are connected via NFC.

16. The page display system according to claim 8, wherein the terminal and the external storage device are connected via Bluetooth.

17. A display interface, comprising:
a target page corresponding to target information, the target page being constructed based on a target page element, the target page element being obtained from hierarchical page elements according to an association with the target information, the target information being obtained from an external storage device.

18. The display interface according to claim 17, wherein the target page element is obtained from the hierarchical page elements according to address information of the target page obtained by performing a read operation on the external storage device.

19. The display interface according to claim 18, wherein the target page element corresponds to reference address information whose similarity with obtained address information is greater than or equal to a preset threshold among the hierarchical page elements.

20. The display interface according to claim 17, wherein the target page element comprises display parameters and first default values of the display parameters, and the target page corresponding to the target information is constructed based on the display parameters and the first default values.
